(19) United States
(12) Patent Application Publication
(10) Pub. No.: US 2025/0029102 A1
(43) Pub. Date: Jan. 23, 2025

(54) SYSTEMS AND METHODS FOR AUTHENTICATING A TRANSACTION WITHIN CLOSE PROXIMITY TO A DESIGNATED OBJECT

(71) Applicant: Capital One Services, LLC, McLean, VA (US)

(72) Inventors: Bryant Yee, Silver Spring, MD (US); Samuel Rapowitz, Roswell, GA (US); Armando Martinez Stone, Arlington, VA (US)

(21) Appl. No.: 18/356,145

(22) Filed: Jul. 20, 2023

(51) Int. Cl. G06Q 20/40; G06F 3/0482; G06Q 20/20; G06Q 20/32

(52) U.S. Cl. CPC G06Q 20/4015; G06F 3/0482; G06Q 20/20; G06Q 20/3224; G06Q 20/327; G06Q 20/4012

(57) ABSTRACT

Disclosed embodiments may include a system for authenticating a transaction within close proximity to a designated object. The system may generate a GUI that may include one or more interactive elements that are configured to allow a user to associate a transaction card with a designated object. The system may receive a user input configured to restrict use of the transaction card to within a specified range of the designated object and transaction data associated with an attempted transaction made at a point-of-sale device. The system may determine a location of the attempted transaction based on the transaction data. The system may receive designated object location data that represents a location of the designated object from a tracking device associated with the designated object. Responsive to determining that the attempted transaction is within the specified range of the designated object, the system may authorize the attempted transaction.

The disclosed technology relates to systems and methods for authenticating a transaction within close proximity to a designated object. Specifically, this disclosed technology relates to providing authentication for a transaction based on a tracked location of a designated object in relation to the location of the attempted transaction.

### BACKGROUND

Transaction cards, such as credit cards, debit cards and the like provide a convenient means of providing payment for purchases. However, such cards may at time be stolen or otherwise compromised by bad actors who may attempt to use the stolen card to make fraudulent purchases. Various techniques may exist to provide a layer of security that attempts to prevent such fraudulent purchases by requiring a form of authentication, such as requiring the purchaser to provide security information (e.g., pin number, card verification value (CVV), etc.) or requiring two-factor authentication in response to an abnormal location of the purchase or other suspicious attributes of a purchase. While such techniques may provide a level of security against fraudulent transactions by thieves, there may be circumstances where a user may want to provide their transaction card to a trusted individual to make purchases in relation to a specific set of circumstances, while still maintaining a level of security against fraud. Further, although providing their card to a trusted individual, the user may nevertheless desire to limit the use of the card by the trusted individual based on certain circumstances that may be dynamic in nature. For example, a parent may temporarily provide a credit card to a babysitter looking after a child, but may only want the babysitter to be able to make purchases pertaining to the child using the card.

Accordingly, there is a need for improved systems and methods for authenticating a transaction within close proximity to a designated object. Embodiments of the present disclosure are directed to this and other considerations.

### SUMMARY

Disclosed embodiments may include a system for authenticating a transaction within close proximity to a designated object. The system may include one or more processors, and memory in communication with the one or more processors and storing instructions that, when executed by the one or more processors, are configured to cause the system to provide authentication of a transaction within close proximity to a designated object. The system may generate a graphical user interface (GUI) configured for display on a user device. The GUI may include one or more interactive elements that are configured to allow a user to associate a transaction card with a designated object. The system may receive, via the GUI, a user input configured to restrict use of the transaction card to within a specified range of the designated object. The system may receive transaction data associated with an attempted transaction. The attempted transaction may include a use of the transaction card at a point-of-sale device. The system may determine a location of the attempted transaction based on the transaction data. The system may receive designated object location data that represents a location of the designated object from a tracking device associated with the designated object. Responsive to determining, based on the location of the attempted transaction and the location of the designated object, that the attempted transaction is within the specified range of the designated object, the system may authorize the attempted transaction.

Disclosed embodiments may include a system for authenticating a transaction within close proximity to a designated object. The system may include one or more processors, and memory in communication with the one or more processors and storing instructions that, when executed by the one or more processors, are configured to cause the system to provide authentication of a transaction within close proximity to a designated object. The system may receive transaction data associated with an attempted transaction. The system may determine a location of the attempted transaction based on the transaction data. The system may receive designated object location data associated with a designated object. The designated object location data may represent a location of the designated object. Responsive to determining, based on the location of the attempted transaction and the location of the designated object, that the location of the attempted transaction is within a specified range of the designated object, the system may authorize the attempted transaction.

Disclosed embodiments may include a system for authenticating a transaction within close proximity to a designated object. The system may include one or more processors, and memory in communication with the one or more processors and storing instructions that, when executed by the one or more processors, are configured to cause the system to provide authentication of a transaction within close proximity to a designated object. The system may receive user credentials to authenticate a user. The system may receive a user input that may provide an instruction to restrict use of a transaction card to a specified area and based on a location of a designated object. The system may receive transaction data associated with an attempted transaction. The system may determine a location of the attempted transaction based on the transaction data. The system may receive designated object location data associated with the designated object. The designated object location data may represent a location of the designated object. Responsive to determining, based on the location of the attempted transaction and the location of the designated object, that the designated object and the attempted transaction are both within the specified area, the system may authorize the attempted transaction.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for authenticating a transaction within close proximity to a designated object in accordance with certain embodiments of the disclosed technology.

FIG. 2 is a flow diagram illustrating an exemplary method for authenticating a transaction within close proximity to a designated object in accordance with certain embodiments of the disclosed technology.

FIG. 3 is block diagram of an example tracked object authorization system used to provide authenticating a transaction within close proximity to a designated object, according to an example implementation of the disclosed technology.

FIG. 4 is block diagram of an example system that may be used to provide authenticating a transaction within close proximity to a designated object, according to an example implementation of the disclosed technology.

### DETAILED DESCRIPTION

Examples of the present disclosure relate to systems and methods for authenticating a transaction within close proximity to a designated object. More particularly, the disclosed technology relates to enabling authentication of transactions in accordance with specified location-based constraints in relation to the geographical position of a designated object that is having its location tracked. Embodiments of the present disclosure allow for a user to specify location-based constraints such as a range or area within which the tracked object must be from the location of the attempted transaction in order to authenticate the transaction. The designated object may be tracked by a tracking device, such as for example, a Bluetooth™ tracker tag that is capable of reporting the geographic position of the tracked object at or about the time of the attempted transaction. Embodiments of the present disclosure can determine the location of an attempted transaction based on transaction data associated with the attempted transaction and compare it to the location of the tracked object to determine if the tracked object is within the specified range/area to authenticate the transaction. This is a technology-based solution that allows a card holder to remotely place constraints on the real-time use of their transaction card by a trusted third party to ensure that the card is used for an intended purpose relating to a tracked object. For example, if a parent wants to provide a teenager with their credit card to allow the teenager to buy gas during the course of a road trip to visit a grandparent, embodiments of the disclosure would allow for the parent to specify that only purchases made within 100 feet of the tracked vehicle are to be authorized. If an attempted purchase is made outside of the specified range/area, in some embodiments, the system may decline the transaction and optionally lock the card or institute other anti-fraud measures. In some embodiments, if the system determines that a purchase has been attempted outside of the specified range/area, instead of immediately declining the transaction, the system may instead prompt the user in real-time to provide an override via, for example, a mobile application on the user's smartphone. Thus, embodiments of the disclosed technology allow a user to remotely manage the usage and security of a transaction card by a third party in real-time in relation to a tracked object.

The systems and methods described herein utilize, in some instances, graphical user interfaces (GUIs), which are necessarily rooted in computers and technology. Graphical user interfaces are a computer technology that allows for user interaction with computers through touch, pointing devices, or other means. The present disclosure details enabling a user to specify geographical constraints on the usage of a transaction card in relation to the location of a tracked object and may include enabling a user to provide real-time input regarding attempted transactions that violate the specified constraints. This, in some examples, may involve using location data of a tracked object and transaction data of an attempted transaction to dynamically change the graphical user interface (GUI) so that the user may manage constraints placed on transaction card usage and respond to real-time attempted usages of the transaction card when necessary, which may involve using payment processing network infrastructure and a tracking device capable of providing a near real-time location of a tracked object. Using a GUI in this way may allow the system to provide location-based authentication constraints on the usage of a transaction card in relation to the location of a tracked object and may also allow a user to remotely manage attempted transactions in real-time (e.g., by overriding a declined transaction).

This is a clear advantage and improvement over prior technologies that provide for static location-based card authentication because such systems restrict authentication of a transaction to predetermined known locations, which is not useful for situations in which a user wants to allow purchases to be made in relation to a dynamic, moving object, such as a vehicle or a person. The present disclosure solves this problem by enabling the user to specify the object being tracked and specify range/area constraints for authorized usage of a transaction card, and by providing a GUI that allows for real-time management of the constraints and attempted transactions. Furthermore, examples of the present disclosure may also improve the speed with which computers can authenticate a transaction by providing for automated authentication in accordance with the pre-specified range/area constraints. Overall, the systems and methods disclosed have significant practical applications in the field of transaction security and authentication because of the noteworthy improvements of the tracked object authentication system described herein, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

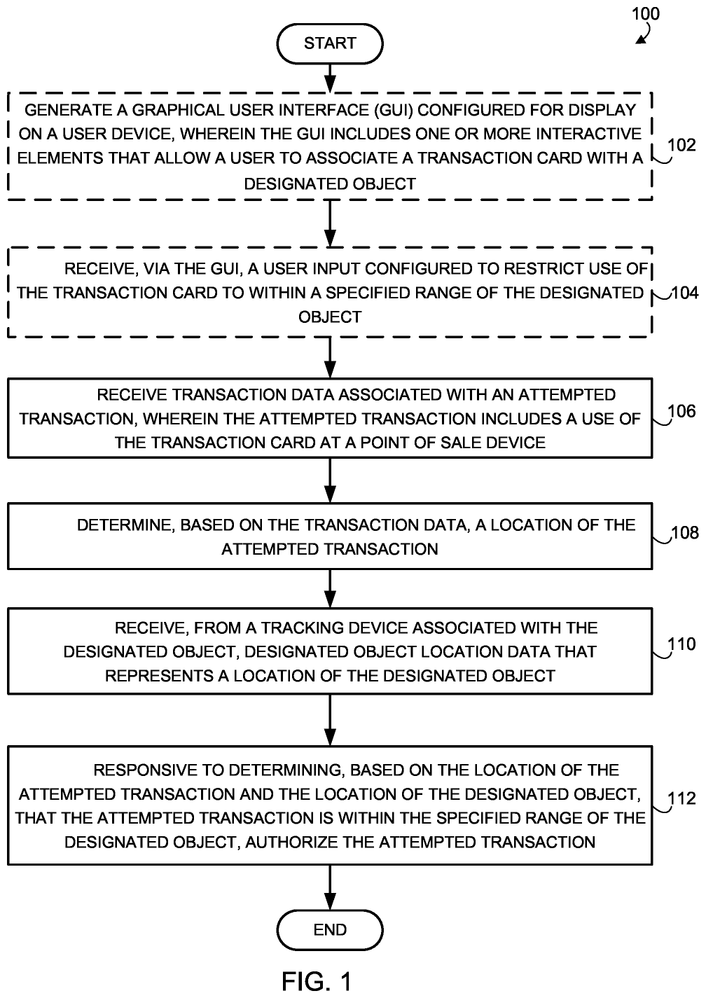

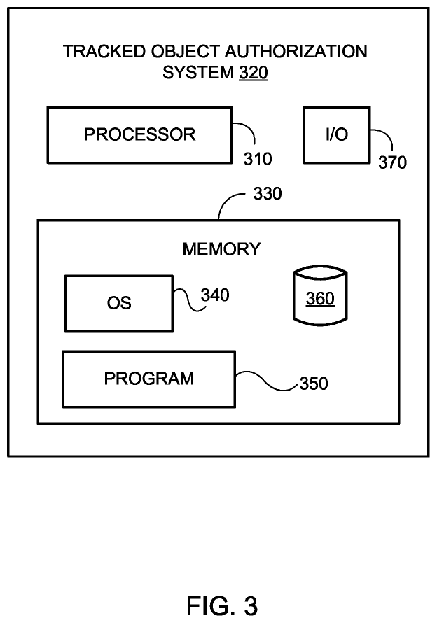

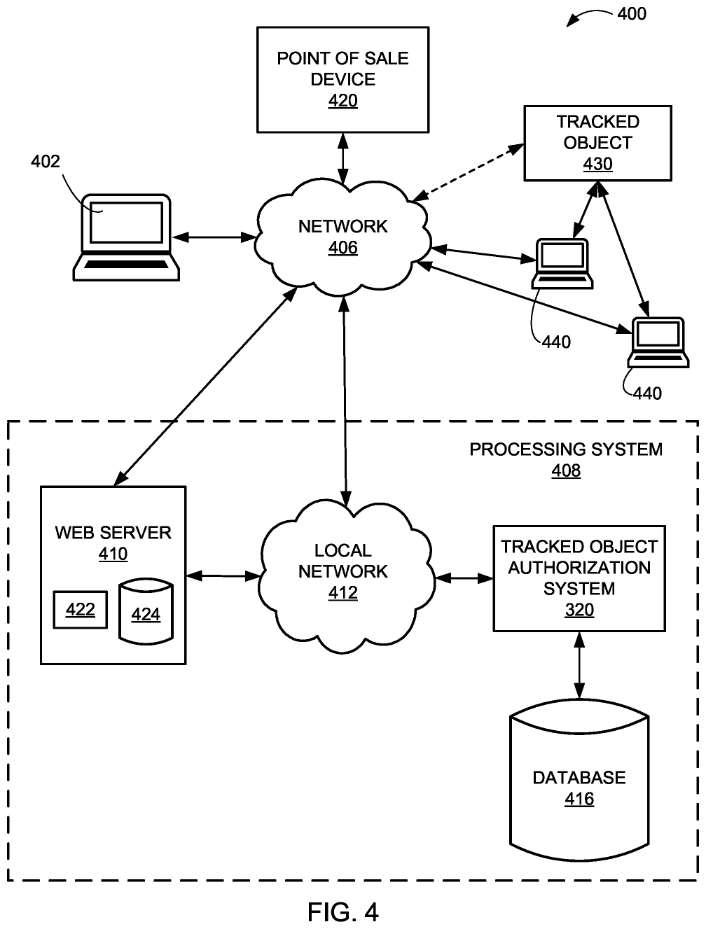

FIG. 1 is a flow diagram illustrating an exemplary method 100 for authenticating a transaction within close proximity to a designated object, in accordance with certain embodiments of the disclosed technology. The steps of method 100 may be performed by one or more components of the system 400 (e.g., tracked object authorization system 320 or web server 410 of processing system 408 or user device 402), as described in more detail with respect to FIGS. 3 and 4. While certain blocks may be identified as being optional, certain embodiments may omit blocks even if they are not necessarily identified as being optional.

In block 102, the tracked object authorization system 320 may optionally generate a GUI configured for display on a user device 402. The GUI may include one or more interactive elements that are configured to allow a user to associate a transaction card with a designated object. For example, the GUI may include interactive elements such as buttons, check boxes, drop down menus, fields, etc., that are configured to receive user input values, and other such interactive elements that may allow a user to associate a transaction card with a designated object. According to some embodiments, the GUI may be displayed by a user device 402 such as a smartphone, in response to, for example, launching a software application on the smartphone. For example, the user device 402 may include a mobile banking software application that is configured to generate a GUI to be displayed by the user device 402. In some embodiments, before accessing the GUI, a user may be required to log into the mobile application by presenting user credentials such as a username and password, biometric data (e.g., facial recognition scan), or other such user authenticating data. In some embodiments, the GUI may display information associated with an account of the user. For example, the GUI may display one or more transaction cards (e.g., credit cards, debit cards, etc.) from which the user may select a transaction card to associate with a designated object. In some embodiments, the GUI may display a list of one or more preregistered designated objects. A preregistered designated object may be an object that is associated with a tracking device that has been registered with the system (e.g., tracked object authorization system 320). By way of example, a user may have placed tracking devices on one or more vehicles, a stroller, and a dog collar worn by a dog. The user may register the tracking devices with the system such that the system may access or receive location data from each tracking device and each registered tracking device may be associated or labeled with an object, so that for example, upon viewing the GUI, the user may be presented with a list of tracked objects that include “Vehicle 1” “Vehicle 2”. “Baby Stroller” and “Dog”, which may be selectable by a user, as described further below.

In block 104, the tracked object authorization system 320 may optionally receive a user input configured to restrict use of the transaction card to within a specified range of the designated object. For example, the user may utilize one or more interactive elements of the GUI displayed on the user device 402 to select the specified range from the designated object, such as by inputting a number of feet or meters as the specified range or selecting a specified range from a predetermined set of options (e.g., select from “20 feet”, “100 feet” or “300 feet”). The user may also utilize one or more interactive elements of the GUI displayed to select the designated object with which to associate the specified range. In other words, the GUI may be configured to allow the user to specify rules that restrict usage of one or more selected transaction cards to within a specified range of a designated object. For example, a user may create a first rule that restricts usage of a first transaction card of the user's account to within 20 feet of “Vehicle 1” and a second rule that restricts usage of the first transaction card and a second transaction card of the user's account to within 100 feet of “Dog”. The GUI may also be configured to allow the user to selectively activate and deactivate the rules. When activated, a rule may operate as an additional authentication to a transaction attempted by a selected card as described below. When deactivated, the rule will have no effect on usage of the transaction card and the card will cease being subject to location-based authentication based on the location of the designated object associated with the deactivated rule.

According to some embodiments, the one or more interactive elements of the GUI may be configured to provide a variety of functionalities to the user, such as for example, but not limited to: associating and/or dissociating a transaction card with one or more designated objects, defining the specified range from a designated object within which an attempted transaction is authorized, restricting use of the transaction card to one or more selected merchants, restricting use of the transaction card to a maximum transaction amount, restricting use of the transaction card to within a specified timeframe, and viewing the location of the designated object on a virtual map. As will be appreciated by those of ordinary skill in the art, transaction details, such as the identity of a merchant, the amount of the transaction, and the date/time of the transaction, can be extracted from transaction data provided by a payment processing system (e.g., using merchant codes, transaction amounts, and timestamps) and thus in some embodiments, the GUI may be configured to allow the user to add additional restrictions to the authorized usage of a selected transaction card based on the merchant identity, amount, and date/time of the transaction. In some embodiments, the GUI may allow a user to implement additional authentication features, such as requiring the user of the card to enter a temporary pin number that may be provided by the owner of the card to the temporary holder of the card. Further, according to some embodiments, the GUI may be configured to display a map that shows the location of the tracked object, for example, in relation to known merchant locations or in relation to a location of an attempted transaction. According to some embodiments, the map may display a near real-time location of the designated object or may display intermittently updated location data of the designated object.

In block 106, the tracked object authorization system 320 may receive transaction data associated with an attempted transaction. The attempted transaction may include or represent a use of the transaction card at a point-of-sale device 420. According to some embodiments, the transaction data may be generated at least in part by a point-of-sale device 420 associated with the attempted transaction. For example, as will be understood by those of ordinary skill in the art, when a card holder utilizes their card at a point-of-sale device 420 (e.g., by swiping the card at a card reader), the point-of-sale device 420 will communicate transaction data to a payment processing network. According to some embodiments, the tracked object authorization system 320 may be configured to communicate with and receive transaction data from one or more payment processing networks, or in some embodiments, the tracked object authorization system 320 may be incorporated as part of a payment processing network such that it receives transaction data generated in response to attempted transactions at various point-of-sale devices 420. The transaction data may include information such as the amount, time, date, merchant code, and other such information. Further, in some embodiments, the point-of-sale device 420 may communicate location information as part of the transaction data, such as for example, longitude and latitude information.

In block 108, the tracked object authorization system 320 may determine a location of the attempted transaction based on the transaction data. For example, in some embodiments, the tracked object authorization system 320 may determine the location of the attempted transaction by determining the location of the point-of-sale device 420 associated with the attempted transaction. According to some embodiments, the tracked object authorization system 320 may determine the location of the point-of-sale device 420 associated with the attempted transaction based on location data received as part of the transaction data, which may include, for example, longitude and latitude information of the point-of-sale device 420. Alternatively, in some embodiments, the tracked object authorization system 320 may store a table of known merchants and their associated locations and may utilize transaction data (e.g., merchant code) to identify the merchant associated with the attempted transaction and perform a lookup of the identified merchant in the table and retrieve the associated known location of the merchant. According to some embodiments, determining the location of the attempted transaction may include obtaining a location of a device used to attempt the transaction in the case where a digital (as opposed to a physical) transaction card is used. For example, in some embodiments, a user device 402, such as a smartphone, may store a digital transaction card that may be used to wirelessly communicate the transaction card information to a point-of-sale device 420. According to some embodiments, the tracked object authorization system 320 may determine a location of the attempted transaction by obtaining location data (e.g., global positioning system (GPS) data) from, for example, a smartphone in response to the smartphone being utilized to present a digital transaction card in an attempt to execute a transaction. For example, in some embodiments, the tracked object authorization system 320 may ping the user device 402 that was used to attempt the transaction for its location in response to receiving transaction data created based on the attempted transaction.

In other embodiments, if the point-of-sale device 420 is unable to transmit transaction data inclusive of information that is sufficient to allow the system to determine the location of the transaction, then the user device 402 associated with the person borrowing the transaction card may be used to determine the location of the transaction. For example, the user device 402 may be preregistered with the tracked object authorization system 320 such that the owner of the transaction card may indicate that they are lending their card to a person associated with the user device 402. According to some embodiments, the tracked object authorization system 320 may be configured to obtain the location of the user device 402, by for example, pinging the user device 402 for its location in response to receiving transaction data indicating that a transaction has been attempted using the transaction card that has been given to the owner of user device 402. The user device 402 may determine its location using GPS or other location tracking systems that are common on smartphone devices. In some embodiments, user device 402 may include software (e.g., a mobile banking software application) that is configured to enable the user device 402 to wirelessly detect (e.g., via Bluetooth™, Wi-Fi, cellular or any other known wireless communication method) and interact with one or more beacon devices having known locations to determine its location. In some embodiments, the user device 402 can be used transmit a location to the transaction card itself within a predetermined time frame before the attempted transaction in order to provide transaction location information to the tracked object authorization system 320. For example, in some embodiments, the user device 402 may be used to validate its location by wirelessly communicating with a beacon of a known location (e.g., via Bluetooth™) to obtain the beacon location data and then may wirelessly communicate the beacon location information to the transaction card (e.g., via near-field communication) such that the transaction card may communicate the beacon location information to the point-of-sale device 420 and cause the beacon location information to be provided in the transaction data. Thus, for example, in some embodiments, if there is a beacon near a store, the user may hold their smartphone near the beacon to obtain the stored beacon location, may then hold their smartphone near the transaction card to wirelessly communicate the beacon location to the transaction card and then if the transaction card is used to make a purchase within a predetermined amount of time (e.g., within 5 minutes), it can be presumed that the location of the transaction is approximately the same or near to the location of the beacon and the system can use this beacon location information to authenticate the transaction.

In block 110, the tracked object authorization system 320 may receive designated object location data that represents a location of the designated object. According to some embodiments, the designated object location data may be received from a tracking device associated with the designated object. For example, a tracking device may be affixed or attached to the designated object such that as the designated object moves, the tracking device may dynamically track the location of the designated/tracked object. According to some embodiments, the designated object location data may include longitude and latitude. According to some embodiments, the designated object location data may include an approximate location obtained from a stored table of known networks and associated locations. For example, if the tracking device is in the vicinity of a known Wi-Fi network having a known location such that the tracking device can detect and/or communicate with the Wi-Fi network (e.g., either directly or indirectly via a Bluetooth™ connection to an intermediary device such as a smartphone), the tracked object authorization system 320 may determine that the approximate location of the designated object corresponds to the known location of the known Wi-Fi network, by, for example, receiving data indicating that the tracking device is in the vicinity of the known Wi-Fi network and performing a lookup in a table of known Wi-Fi networks and their associated locations.

According to some embodiments, the tracking device may include a Bluetooth™ tracker tag that is configured to wirelessly communicate with nearby network-connected devices in order to report a location of the tracked object. In some embodiments, the tracking device may include a GPS device that is capable of wirelessly communicating its location to the tracked object authorization system 320.

According to some embodiments, the tracking device may be configured to continuously or intermittently transmit location data. According to some embodiments, receiving designated object location data may include intermittently passively receiving tracking device location information from the tracking device. Thus, the location of the designated object may correspond to tracking device location information that was most recently received from the tracking device and the location of the designated object may be considered to be the most recently reported location based on the intermittently received tracking device location information. In some embodiments, the tracking device may be configured to provide location data in response to a request. For example, in some embodiments, the tracked object authorization system 320 may ping the tracking device to request the designated object location data in response to receiving transaction data associated with an attempted transaction made using a transaction card that is associated with an activated rule that restricts usage of the transaction card to within a specified distance or area from a designated object. In this way, the tracked object authorization system 320 can determine the location of the designated/tracked object nearly simultaneously (e.g., within a few seconds) to the usage of the transaction card to attempt a transaction.

In block 112, the tracked object authorization system 320 may authorize the attempted transaction in response to determining, based on the location of the attempted transaction and the location of the designated object, that the attempted transaction is within the specified range of the designated object. In other words, in some embodiments, the tracked object authorization system 320 may compare the location of the attempted transaction to the location of the designated object to determine if the designated object is within the specified range of the attempted transaction to determine whether or not to authorize or decline the attempted transaction.

According to some embodiments of method 100, the tracked object authorization system 320 may be configured to decline the attempted transaction in response to determining, based on the location of the attempted transaction and the location of the designated object, that the location of the attempted transaction is not within the specified range of the designated object. Alternatively, in some embodiments, in response to determining that the designated object is outside of the specified range of the attempted transaction, the tracked object authorization system 320 may be configured to transmit a prompt to a user device 402 associated with the owner of the transaction card to allow the owner to override a provisional declination of the transaction (e.g., via interactive elements of a GUI). For example, in some embodiments, the prompt may provide information about the transaction such as the amount, the identity of the merchant, the time, the location of the transaction, and the location of the designated object. In some embodiments, the GUI may display a map that depicts the relative locations of the attempted transaction and the designated object so that the user may see where the designated object is located relative to the attempted transaction to determine whether an override may be warranted. For example, if the tracked object is a vehicle and the transaction card owner can see on the map that although the vehicle is parked at a gas station, the gas station has an unusually large parking lot, and the exact location of the parked car may be outside of the 100 ft specified range of the transaction, the card owner may nonetheless opt to authorize the transaction. Upon receiving an authorization override in this manner, the tracked object authorization system 320 may communicate to a payment processing network that the transaction is authorized, which may then approve and execute the transaction.

According to some embodiments, the tracked object authorization system 320 can provide feedback and notifications to a user device 402 associated with the owner of the transaction card in response to an attempted transaction. For example, the tracked object authorization system 320 may provide a notification (e.g., via a GUI of user device 402) to the owner of the transaction card that a transaction was approved or declined immediately after it occurs. The notification may provide information such as the amount, merchant, time, date, transaction location, and/or tracked object location. As described above, in some embodiments, when the designated object is determined to be outside of the specified range/area of the attempted transaction, the tracked object authorization system 320 may be configured to provide the owner of the transaction card with a prompt that provides an opportunity to override a provisional declination of the transaction. In some embodiments, the prompt may expire after a predetermined amount of time (e.g., one minute) and the transaction may automatically be declined within the predetermined amount of time without receiving a response from the card owner.

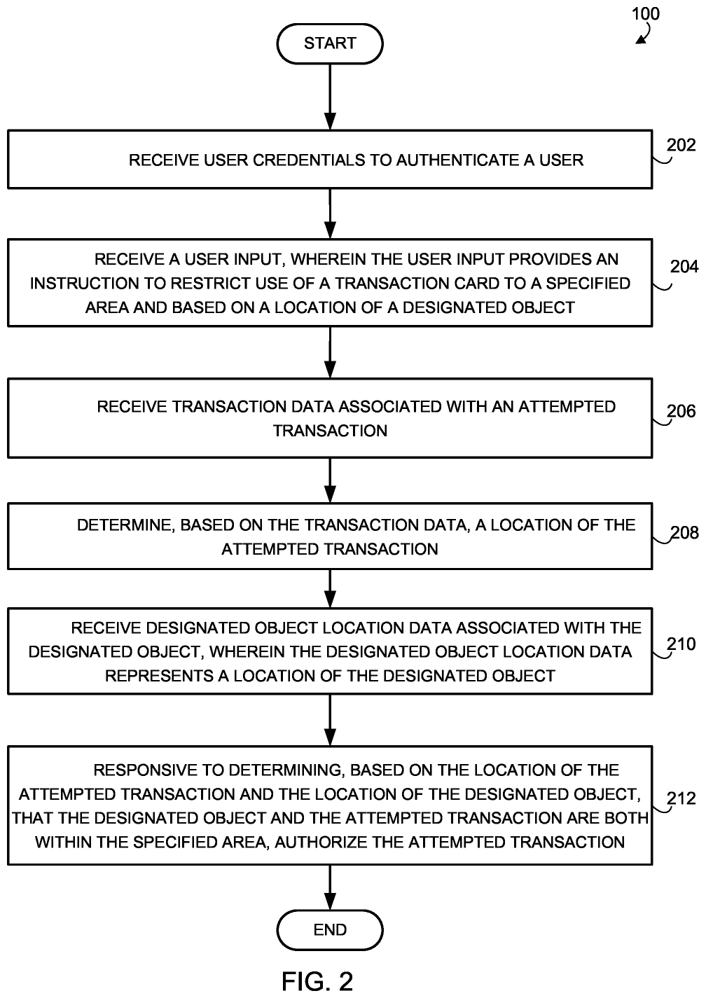

FIG. 2 is a flow diagram illustrating an exemplary method 200 for authenticating a transaction within close proximity to a designated object, in accordance with certain embodiments of the disclosed technology. The steps of method 200 may be performed by one or more components of the system 400 (e.g., tracked object authorization system 320 or web server 410 of processing system 408 or user device 402), as described in more detail with respect to FIGS. 3 and 4.

Method 200 of FIG. 2 is similar to method 100 of FIG. 1, except that method 200 may not include blocks 108 or 114 of method 100. The descriptions of blocks 206, 208, and 210 in method 200 are similar to the respective descriptions of blocks 106, 108, and 110 of method 100 and are not repeated herein for brevity. However, blocks 202, 204 and 212 are different from block 102, 104 and 112 and are described below. While certain blocks may be identified as being optional, certain embodiments may omit blocks even if they are not necessarily identified as being optional.

In block 202, the tracked object authorization system 320 may receive user credentials to authenticate a user. User credentials may include, for example, a username and password, biometric data (e.g., facial recognition), two-factor authentication data (e.g., pin code), and other such data as may be known to authenticate a user to, for example, log into an account. In some embodiments, user credentials may be received by a mobile application running on the user device 402 and communicated to the tracked object authorization system 320 or processing system 408 to allow a user to log into an account that allows the user to manage the security and usage of transaction cards, as described herein.

In block 204, the tracked object authorization system 320 may receive a user input that may provide an instruction to restrict use of a transaction card to a specified area and based on a location of a designated object. For example, user device 402 may provide an interactive GUI that is configured to allow a user to select one or more transaction cards associated with their account, one or more preregistered designated objects that are each associated with a tracking device and specify an area within which use of the transaction card is authorized provided that both the transaction and the designated object are within the designated area at the time the attempted transaction is made. Thus, according to some embodiments, the user input may include an input to a GUI of a user device 402 that designates the specified area. In some embodiments, the specified area may be selected from a number of saved or predetermined specified areas (e.g., selecting an area that corresponds to the footprint of a mall or an amusement park). In some embodiments, the specified area may be an area centered around the location of the designated object in accordance with a specified shape (e.g., a 100 ft radius around the designated object or a square block centered on the designated object having 100 ft sides, etc.). In some embodiments, the specified area may be a static area that is designated by, for example, drawing an area (e.g., a geofence) on an interactive map presented by a GUI. For example, if a card owner is giving their credit card to a babysitter who is taking a child on a bike ride, the card owner may know the route of the bike ride and may trace an area around the known route as an authorized area in which the babysitter may stop and make purchases (e.g., stop and buy drinks), thereby preventing purchases from being made in areas that are not along the planned bike ride route.

In block 206, the tracked object authorization system 320 may receive transaction data associated with an attempted transaction in a manner similar to that described above with respect to block 106.

In block 208, the tracked object authorization system 320 may determine a location of the attempted transaction based on the transaction data in a manner similar to that described above with respect to block 108.

In block 210, the tracked object authorization system 320 may receive designated object location data associated with the designated object (e.g., in a manner similar to that described with respect to block 110 above). The designated object location data may represent a location of the designated object. According to some embodiments, the designated object location data may be received from a tracking device that is associated with the designated object.

In block 212, the tracked object authorization system 320 may authorize the attempted transaction in response to determining, based on the location of the attempted transaction and the location of the designated object, that the designated object and the attempted transaction are both within the specified area. For example, if the specified area is a static area of a map (e.g., a geofence) as designated by the card owner, the tracked object authorization system 320 may authorize the transaction upon determining that both the location of the attempted transaction and the location of the designated object are contained within the boundaries of the specified area. If the specified area is an area that has been designated around the designated object (e.g., a square area having 100 ft sides centered on the designated object) then the tracked object authorization system 320 may authorize the transaction upon determining that the location of the attempted transaction is also within the bounds of the specified area. In some embodiments, if the tracked object authorization system 320 determines that the location of either the attempted transaction or the designated object is outside of the specified area, then the transaction may be declined or the card owner may be notified of a provisional declination and given the opportunity to override the declination and authorize the transaction (e.g., via a GUI of the user device 402).

FIG. 3 is a block diagram of an example tracked object authorization system 320 used to authenticate and authorize transaction based on the locations of the attempted transaction and on the location of a designated object as specified by the account owner, according to an example implementation of the disclosed technology. According to some embodiments, the user device 402, web server 410, point-of-sale device 420, and network-connected device(s) 440, as depicted in FIG. 4 and described below, may have a similar structure and components that are similar to those described with respect to tracked object authorization system 320 shown in FIG. 3. As shown, the tracked object authorization system 320 may include a processor 310, an input/output (I/O) device 370, a memory 330 containing an operating system (OS) 340, and a program 350. In certain example implementations, the tracked object authorization system 320 may be a single server or may be configured as a distributed computer system including multiple servers or computers that interoperate to perform one or more of the processes and functionalities associated with the disclosed embodiments. In some embodiments tracked object authorization system 320 may be one or more servers from a serverless or scaling server system. In some embodiments, the tracked object authorization system 320 may further include a peripheral interface, a transceiver, a mobile network interface in communication with the processor 310, a bus configured to facilitate communication between the various components of the tracked object authorization system 320, and a power source configured to power one or more components of the tracked object authorization system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™4 port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the tracked object authorization system 320 may include one or more storage devices configured to store information used by the processor 310 (or other components) to perform certain functions related to the disclosed embodiments. In one example, the tracked object authorization system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The tracked object authorization system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the tracked object authorization system 320 may include the memory 330 that may include one or more programs 350 to perform one or more functions of the disclosed embodiments. For example, in some embodiments, the tracked object authorization system 320 may additionally manage dialogue and/or other interactions with a user via a program 350.

The processor 310 may execute one or more programs 350 located remotely from the tracked object authorization system 320. For example, the tracked object authorization system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a tracked object authorization system database 360 for storing related data to enable the tracked object authorization system 320 to perform one or more of the processes and functionalities associated with the disclosed embodiments. For example, the tracked object authorization database 360 may store information relating to user accounts, transaction cards, transaction data, designated objects and associated tracking devices, tables of known merchants or Wi-Fi networks and their associated locations, maps, and other such information as may be useful in achieving the functionalities described herein. According to some embodiments, the functions provided by the tracked object authorization system database 360 may also be provided by a database that is external to the tracked object authorization system 320, such as the database 416 as shown in FIG. 4.

The tracked object authorization system 320 may also be communicatively connected to one or more memory devices (e.g., databases) locally or through a network. The remote memory devices may be configured to store information and may be accessed and/or managed by the tracked object authorization system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The tracked object authorization system 320 may also include one or more I/O devices 370 that may comprise one or more interfaces for receiving signals or input from devices and providing signals or output to one or more devices that allow data to be received and/or transmitted by the tracked object authorization system 320. For example, the tracked object authorization system 320 may include interface components, which may provide interfaces to one or more input devices, such as one or more keyboards, mouse devices, touch screens, track pads, trackballs, scroll wheels, digital cameras, microphones, sensors, and the like, that enable the tracked object authorization system 320 to receive data from a user (such as, for example, via the user device 402).

In examples of the disclosed technology, the tracked object authorization system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the tracked object authorization system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the tracked object authorization system 320 may include a greater or lesser number of components than those illustrated.

According to some embodiments, the tracked object authorization system 320 may be configured to provide authentication and/or authorization of an attempted transaction based on the application of a user-defined rule specifying a range or area relative to the location of a designated object within which an attempted transaction may be authorized. The tracked object authorization system 320 may be configured to generate one or more GUIs for display by a user device 402. The GUIs may include interactive elements that allow an owner of a transaction card to specify that the authorized use of a selected transaction card can be geographically restricted relative to the dynamic location of a designated object. The tracked object authorization system 320 may be configured to receive transaction data from an attempted transaction (e.g., from a payment processing network) associated with a transaction card and may also receive designated object location data associated with the designated object, from which the tracked object authorization system 320 may determine a location of the attempted transaction and a location of the designated object, respectively. Based on these locations, the tracked object authorization system 320 may determine whether the attempted transaction is within the specified range or area of the designated object and cause the transaction to either be authorized or declined based on this determination. In some embodiments, if the attempted transaction is determined to be outside of the specified range or area, instead of immediately declining the transaction, the tracked object authorization system 320 may provide a prompt to the owner of the transaction card (e.g., via user device 402) to provide the owner with an opportunity to override the declination and approve the transaction.

FIG. 4 is a block diagram of an example system that may be used to view and interact with processing system 408, according to an example implementation of the disclosed technology. The components and arrangements shown in FIG. 4 are not intended to limit the disclosed embodiments as the components used to implement the disclosed processes and features may vary. As shown, processing system 408 may interact with a user device 402 via a network 406. In certain example implementations, the processing system 408 may include a local network 412, a tracked object authorization system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the processing system 408. In some embodiments, the user device 402 may include or incorporate electronic communication devices for hearing or vision impaired users.

Users may include individuals such as, for example, subscribers, clients, or customers of an entity associated with an organization, such as individuals who have obtained, will obtain, or may obtain a product, service, or consultation from or conduct a transaction in relation to an entity associated with the processing system 408. According to some embodiments, users may include owners or authorized users of one or more transaction cards (e.g., credit cards, debit cards, etc.). According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 may be of any suitable type, including individual connections via the internet such as cellular or WiFi networks. In some embodiments, the network 406 may connect terminals, services, and mobile devices using direct connections such as RFID, NFC, Bluetooth™, BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The processing system 408 may be associated with and optionally controlled by one or more entities such as a business, corporation, individual, partnership, or any other entity that provides one or more of goods, services, and consultations to individuals such as customers. In some embodiments, the processing system 408 may be controlled by a third party on behalf of another business, corporation, individual, partnership. The processing system 408 may include one or more servers and computer systems for performing one or more functions associated with products and/or services that the organization provides. According to some embodiments, the processing system 408 or aspects of the processing system 408 may be incorporated as part of a payment processing system.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the tracked object authorization system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™. According to some embodiments, the web server 410 may be configured to interact with the user device 402 to provide a GUI for display in software application running on the user device 402. The GUI may include interactive elements configured to receive user inputs that may be communicated to the web server 410 and/or tracked object authorization system 320.

The local network 412 may include any type of computer networking arrangement used to exchange data in a localized area, such as WiFi, Bluetooth™, Ethernet, and other suitable network connections that enable components of the processing system 408 to interact with one another and to connect to the network 406 for interacting with components in the system 400 environment. In some embodiments, the local network 412 may include an interface for communicating with or linking to the network 406. In other embodiments, certain components of the processing system 408 may communicate via the network 406, without a separate local network 406.

The processing system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access processing system 408 using the cloud computing environment. User device 402 may be able to access processing system 408 using specialized software. The cloud computing environment may eliminate the need to install specialized software on user device 402.

In accordance with certain example implementations of the disclosed technology, the processing system 408 may include one or more computer systems configured to compile data from a plurality of sources, the tracked object authorization system 320, web server 410, and/or the database 416. The tracked object authorization system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

With continued reference to FIG. 4, the point-of-sale device 420 may include a computer system to initiate purchase transactions by reading transaction card data from one or more transaction cards presented for payment during a transaction. As will be appreciated by those of ordinary skill in the art, a point-of-sale device 420 may take various forms, such as for example an electronic cash register, a self-checkout kiosk, a handheld payment device or another type of computing device capable of reading or receiving transaction card data. In some embodiments, the point-of-sale device 420 may include a keypad for manually entering transaction card information, a card reading device into which a transaction card can be inserted or swiped within to read data from a card, a wireless chip reader to wireless receive card data from a chip embedded in a transaction card, or other wireless transceivers for wireless receiving transaction card information from a transaction card or wireless device containing a virtual transaction card (e.g., a smartphone having a virtual wallet that includes one or more transaction cards). Upon a transaction card being swiped or otherwise read to initiate a payment for a purchase, the point-of-sale device 420 may generate transaction data and communicate with a payment processing network to request authentication and/or authorization for the transaction. Such transaction data may include a total cost of the transaction, the transaction card number of the card being used to pay for the transaction, the date and time of the transaction, a merchant code or other merchant identifying information, location data (e.g., longitude and latitude of the point-of-sale device 420), and other such data relating to the attempted transaction. Upon receiving an authorization from the payment processing system, the point-of-sale device 420 may complete the transaction. In some instances, the point-of-sale device 420 may receive a declination of the transaction that may result in the cancellation of the transaction by the point-of-sale device 420.

According to some embodiments, the tracked object 430 may be an object that is associated with a tracking device that can dynamically track the location of the tracked object 430. The tracked object can be any object that a user of the system desires to track, such as for example but not limited, a vehicle, a stroller, a dog collar, a piece of clothing, a person, or an object such as a computing device. In some embodiments, the tracking device may be a Bluetooth™ tracker tag that may be configured to be attached to the tracked object 430 (e.g., via an adhesive) and may be further configured to wirelessly communicate with one or more network-connected devices 440. A network-connected device 440 may be any device that is connected to the network 406 and may include devices having wired connections (e.g., ethernet) and/or wireless connections (e.g., Wi-Fi, cellular network, satellite communications, etc.). As will be understood by those of ordinary skill in the art, a Bluetooth™ tracker tag may communicate with a network-connected device 440 to report its location. In some embodiments, a network-connected device 440 may be a Wi-Fi connected smartphone that includes GPS. The Bluetooth™ tracker tag may report its position by causing the Wi-Fi connected smartphone to determine its location using GPS and then communicate its location to a server (e.g., web server 410 or tracked object authorization system 320) via the Wi-Fi network (e.g., network 406). In some embodiments, the tracking device may be specifically paired with the network-connected device 440 in order to communicate with it. For example, if the transaction card is provided to a babysitter, the tracking device may be paired with the babysitter's phone by, for example, the using a mobile application installed on the babysitter's phone that is configured to receive a code provided by the owner of the tracking device that is linked to the identity of the tracking device. In other embodiments, a tracking device may not need to be paired with a specific device but may rather be configured to communicate with a plurality of devices that are part of a pre-authorized network (e.g., a certain brand of tracker tag may be configured to openly communicate with any network-connected device 440 of the same brand, manufacturer and/or service provider). In some embodiments, the tracking device may be configured to determine and communicate its location without communicating with a network-connected device 440. For example, in some embodiments, the tracking device may include GPS technology that allows it to determine its own longitude and latitude and may include a transceiver that is capable of wirelessly communicating with a Wi-Fi, cellular or other such wireless network. Further, in some embodiments, a tracking device may determine its own location using other methods, such as for example, triangulating wireless signals from cellular towers or Wi-Fi routers of known locations, approximating a location by detecting one or more networks having a known location (e.g., if the tracking device detects a Wi-Fi network named “Outlet Mall Wi-Fi” it may be determined that the tracked object is located within or near to the Outlet Mall), or any other such method that may be used to determine the location of a device.

Although the preceding description describes various functions of a web server 410, a tracked object authorization system 320, a database 416 and a user device 402, according to various embodiments, some or all of these functions may be carried out by a single computing device.

### EXAMPLE USE CASE

The following example use case describes an example of a typical user flow pattern. This section is intended solely for explanatory purposes and not in limitation.

In one example, the John may want to loan his credit card his teenage daughter, Jane, to allow her to buy gas, food and other necessary items during a road trip she is going on to visit a grandparent in another city. While John wants to provide for the essentials that may arise during Jane's trip, he is weary of the possibility that the card may be lost or stolen or that Jane may attempt to use the card for non-road trip related expenses. John can log into a mobile banking software application on his smartphone (e.g., user device 402) and indicate that Jane's car is a tracked object by pairing/associating/linking a tracking device (e.g., a Bluetooth™ tracker tag) affixed to Jane's car with his account and labeling the tracking device information as being associated with Jane's car. John can then create a rule by selecting Jane's car as designated object, selecting a transaction card (i.e., the card being provided by John to Jane) to which the rule applies, and then inputting a specified range or area around the designated object within which transactions are authorized, such as for example, “200 feet”, and John may activate the rule (e.g., by toggling an “on/off” button). Upon activating the rule, the system (e.g., tracked object authorization system 320) will monitor transaction data for transactions relating to the specified transaction card, and upon identifying that a transaction using the card has been attempted, will then determine the relative locations of both Jane's vehicle and the location of the attempted purchase (e.g., the location of the point-of-sale device 420 at which the card was swiped). If the system determines that the two are within 200 feet of one another, then it will authorize the transaction to be executed (e.g., pending any additional authentication/authorization measures that may be in place within the system). If the system determines that the location of the attempted transaction is further than 200 feet away from the location of Jane's vehicle, then it may either decline the transaction or provide John with the opportunity to override the declination and authorize the transaction, by, for example, presenting John with a prompt (e.g., via a GUI of user device 402) that provides information about the attempted transaction, such as for example the amount, the location of the transaction, the location of Jane's vehicle, and/or the distance between Jane's vehicle and the location of the attempted transaction. In this way, the system can allow John to safely lend his credit card to Jane for use during her road trip, while limiting the use of the card to within 200 feet of the vehicle to prevent fraudulent charges that are a result of theft of the card and/or to prevent Jane from using the card for non-trip related expenses (as may be indicated by purchases that are made a greater distance away from her vehicle).

In another example, a user may not want to lend their card to another person, but rather may simply want to use the system as protection against their card being used for fraudulent charges as a result of being stolen or lost. In such a case, the user may select themself or an object they always carry (e.g., their smartphone) as the designated/tracked item. For example, the user may select their smartphone as the tracked item. Smartphones typically include location tracking capabilities such as GPS systems and therefore it may be unnecessary to add or register any additional third-party tracking device to the phone. The user can register their smartphone with their account, select it as the designated object, select one or more transaction cards to associate with the rule, indicate a specified range (e.g., 20 feet) within which transactions are authorized, and may activate the rule. Thus, assuming the user carries their smartphone (e.g., user device 402) with them everywhere they go, the system (e.g., tracked object authorization system 320) will authorize transactions the user makes using the selected card(s) because the user's location as determined by the phone should always be in close proximity to the location of the attempted transaction. However, if the user's card is lost or stolen, the system (e.g., tracked object authorization system 320) may operate to immediately prevent fraudulent charges from being transacted if the transactions are attempted anywhere but within an immediate proximity to the user (e.g., within 20 feet in this example).

In some examples, disclosed systems or methods may involve one or more of the following clauses:

Clause 1: A system comprising: one or more processors; memory in communication with the one or more processors and storing instructions that are configured to cause the system to: generate a graphical user interface (GUI) configured for display on a user device, wherein the GUI comprises one or more interactive elements that are configured to allow a user to associate a transaction card with a designated object; receive, via the GUI, a user input configured to restrict use of the transaction card to within a specified range of the designated object; receive transaction data associated with an attempted transaction, wherein the attempted transaction comprises a use of the transaction card at a point-of-sale device; determine, based on the transaction data, a location of the attempted transaction; receive, from a tracking device associated with the designated object, designated object location data that represents a location of the designated object; and responsive to determining, based on the location of the attempted transaction and the location of the designated object, that the attempted transaction is within the specified range of the designated object, authorize the attempted transaction.

Clause 2: The system of clause 1, wherein determining the location of the attempted transaction comprises determining a location of the point-of-sale device.

Clause 3: The system of clause 2, wherein the tracking device comprises a Bluetooth tracker tag.

Clause 4: The system of clause 3, wherein the instructions are further configured to cause the system to: ping the tracking device to request the designated object location data in response to receiving the transaction data associated with the transaction.

Clause 5: The system of clause 3, wherein receiving designated object location data comprises intermittently passively receiving tracking device location information from the tracking device and wherein the location of the designated object corresponds to tracking device location information that was most recently received from the tracking device.

Clause 6: The system of clause 1, wherein the instructions are further configured to cause the system to: responsive to determining, based on the location of the attempted transaction and the location of the designated object, that the location of the attempted transaction is not within the specified range of the designated object, decline the attempted transaction.

Clause 7: The system of clause 1, wherein the one or more interactive elements of the GUI are further configured to allow a user to perform one or more of: dissociate the transaction card with the designated object; define the specified range; restrict use of the transaction card to one or more selected merchants; restrict use of the transaction card to a maximum transaction amount; restrict use of the transaction card to within a specified timeframe; and view the location of the designated object on a virtual map.

Clause 8: A system comprising: one or more processors; memory in communication with the one or more processors and storing instructions that are configured to cause the system to: receive transaction data associated with an attempted transaction; determine, based on the transaction data, a location of the attempted transaction; receive designated object location data associated with a designated object, wherein the designated object location data represents a location of the designated object; and responsive to determining, based on the location of the attempted transaction and the location of the designated object, that the location of the attempted transaction is within a specified range of the designated object, authorize the attempted transaction.

Clause 9: The system of clause 8, wherein the transaction data is generated at least in part by a point-of-sale device associated with the attempted transaction.

Clause 10: The system of clause 9, wherein determining the location of the attempted transaction comprises determining a location of the point-of-sale device.

Clause 11: The system of clause 8, wherein the designated object location data is received from a tracking device that is associated with the designated object.

Clause 12: The system of clause 11, wherein the tracking device comprises a Bluetooth tracker tag.

Clause 13: The system of clause 11, wherein the instructions are further configured to cause the system to: responsive to receiving an indication of the attempted transaction, ping the tracking device to request the designated object location data.

Clause 14: The system of clause 8, wherein the instructions are further configured to cause the system to: responsive to determining, based on the location of the attempted transaction and the location of the designated object, that the location of the attempted transaction is not within the specified range of the designated object, decline the attempted transaction.

Clause 15: A system comprising: one or more processors; memory in communication with the one or more processors and storing instructions that are configured to cause the system to: receive user credentials to authenticate a user; receive a user input, wherein the user input provides an instruction to restrict use of a transaction card to a specified area and based on a location of a designated object; receive transaction data associated with an attempted transaction; determine, based on the transaction data, a location of the attempted transaction; receive designated object location data associated with the designated object, wherein the designated object location data represents a location of the designated object; and responsive to determining, based on the location of the attempted transaction and the location of the designated object, that the designated object and the attempted transaction are both within the specified area, authorize the attempted transaction.

Clause 16: The system of clause 15, wherein the transaction data is generated at least in part by a point-of-sale device associated with the attempted transaction.

Clause 17: The system of clause 16, determining the location of the attempted transaction comprises determining a location of the point-of-sale device.

Clause 18: The system of clause 15, wherein the designated object location data is received from a tracking device that is associated with the designated object.

Clause 19: The system of clause 18, wherein the tracking device comprises a Bluetooth tracker tag.

Clause 20: The system of clause 15, wherein the user input comprises an input to a graphical user interface of a user device that designates the specified area.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those of ordinary skill in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person of ordinary skill in the art to practice certain embodiments of this technology, including making and using any apparatuses or systems and performing any incorporated methods. The patentable scope of certain embodiments of the technology is defined in the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors;
memory in communication with the one or more processors and storing instructions that are configured to cause the system to:
generate a graphical user interface (GUI) configured for display on a user device, wherein the GUI comprises one or more interactive elements that are configured to allow a user to associate a transaction card with a designated object;
receive, via the GUI, a user input configured to restrict use of the transaction card to within a specified range of the designated object;
receive transaction data associated with an attempted transaction, wherein the attempted transaction comprises a use of the transaction card at a point-of-sale device;
determine, based on the transaction data, a location of the attempted transaction;
receive, from a tracking device associated with the designated object, designated object location data that represents a location of the designated object; and
responsive to determining, based on the location of the attempted transaction and the location of the designated object, that the attempted transaction is within the specified range of the designated object, authorize the attempted transaction.

2. The system of claim 1, wherein determining the location of the attempted transaction comprises determining a location of the point-of-sale device.

3. The system of claim 2, wherein the tracking device comprises a Bluetooth tracker tag.

4. The system of claim 3, wherein the instructions are further configured to cause the system to:
ping the tracking device to request the designated object location data in response to receiving the transaction data associated with the transaction.

5. The system of claim 3, wherein receiving designated object location data comprises intermittently passively receiving tracking device location information from the tracking device and wherein the location of the designated object corresponds to tracking device location information that was most recently received from the tracking device.

6. The system of claim 1, wherein the instructions are further configured to cause the system to:
responsive to determining, based on the location of the attempted transaction and the location of the designated object, that the location of the attempted transaction is not within the specified range of the designated object, decline the attempted transaction.

7. The system of claim 1, wherein the one or more interactive elements of the GUI are further configured to allow a user to perform one or more of:
dissociate the transaction card with the designated object;
define the specified range;
restrict use of the transaction card to one or more selected merchants;
restrict use of the transaction card to a maximum transaction amount;
restrict use of the transaction card to within a specified timeframe; and
view the location of the designated object on a virtual map.

8. A system comprising:
one or more processors;
memory in communication with the one or more processors and storing instructions that are configured to cause the system to:
receive transaction data associated with an attempted transaction;
determine, based on the transaction data, a location of the attempted transaction;
receive designated object location data associated with a designated object, wherein the designated object location data represents a location of the designated object; and
responsive to determining, based on the location of the attempted transaction and the location of the designated object, that the location of the attempted transaction is within a specified range of the designated object, authorize the attempted transaction.

9. The system of claim 8, wherein the transaction data is generated at least in part by a point-of-sale device associated with the attempted transaction.

10. The system of claim 9, wherein determining the location of the attempted transaction comprises determining a location of the point-of-sale device.

11. The system of claim 8, wherein the designated object location data is received from a tracking device that is associated with the designated object.

12. The system of claim 11, wherein the tracking device comprises a Bluetooth tracker tag.

13. The system of claim 11, wherein the instructions are further configured to cause the system to:
responsive to receiving an indication of the attempted transaction, ping the tracking device to request the designated object location data.

14. The system of claim 8, wherein the instructions are further configured to cause the system to:
responsive to determining, based on the location of the attempted transaction and the location of the designated object, that the location of the attempted transaction is not within the specified range of the designated object, decline the attempted transaction.

15. A system comprising:
one or more processors;
memory in communication with the one or more processors and storing instructions that are configured to cause the system to:
receive user credentials to authenticate a user;
receive a user input, wherein the user input provides an instruction to restrict use of a transaction card to a specified area and based on a location of a designated object;
receive transaction data associated with an attempted transaction;
determine, based on the transaction data, a location of the attempted transaction;
receive designated object location data associated with the designated object, wherein the designated object location data represents a location of the designated object; and
responsive to determining, based on the location of the attempted transaction and the location of the designated object, that the designated object and the attempted transaction are both within the specified area, authorize the attempted transaction.

16. The system of claim 15, wherein the transaction data is generated at least in part by a point-of-sale device associated with the attempted transaction.

17. The system of claim 16, determining the location of the attempted transaction comprises determining a location of the point-of-sale device.

18. The system of claim 15, wherein the designated object location data is received from a tracking device that is associated with the designated object.

19. The system of claim 18, wherein the tracking device comprises a Bluetooth tracker tag.

20. The system of claim 15, wherein the user input comprises an input to a graphical user interface of a user device that designates the specified area.
